(19) United States
(12) Patent Application Publication
(10) Pub. No.: US 2013/0181971 A1
(43) Pub. Date: Jul. 18, 2013

(54) Automatic Plane Alignment in 3D Environment

(71) Applicant: Eric J. Mueller, Los Gatos, CA (US)

(72) Inventor: Eric J. Mueller, Los Gatos, CA (US)

(73) Assignee: Motorola Mobility, Inc., Libertyville, IL (US)

(21) Appl. No.: 13/348,726

(22) Filed: Jan. 12, 2012

(51) Int. Cl. G06T 15/00

(52) U.S. Cl. 345/419

(57) ABSTRACT

In one embodiment, a method determines a first plane in a plurality of planes that is active for placing elements in a three dimensional (3D) space. A changing of a viewing direction of the first plane in the 3D space is detected. The method determines when a second plane in the plurality of planes should be activated for placing elements based on the changing of the viewing direction. The second plane is then activated for placing elements in the 3D space. The second plane is oriented at a different angle than the first plane with respect to the viewing direction.

### BACKGROUND

Particular embodiments generally relate to three-dimensional (3D) authoring tools.

3D authoring tools may be difficult for users to use when they are not familiar with working in a 3D space. A plane is provided where users can place elements on the plane. The 3D space may then be viewed from different directions. For example, a user may rotate a plane to view elements from a different viewing direction (e.g., the viewing direction may be from a position to the right of the elements). When the plane is rotated, the plane may become “ill-conditioned” or “edge-on” to the viewing direction. An ill-conditioned or edge-on plane is when the plane has a normal that is substantially perpendicular to the viewing direction.

FIG. 1 shows an example of a plane that has become ill-conditioned or edge-on. As shown, an interface 100 includes a plane 102 in which users can place elements. The user has rotated plane 102 such that a viewing direction is substantially down the negative X direction. In this case, the surface in which a user can place an element is very limited because plane 102 is edge-on to the viewing direction. Thus, when a user attempts to place an element on plane 102, the placed element may be positioned and/or oriented in the 3D space not exactly how the user intended. For example, to place element 104 into the 3D space, a user may define two points 106-1 and 106-2 in the 3D space on interface 100 to place element 104. Because plane 102 is substantially parallel to the viewing direction, element 104 is placed onto plane 102 in a position and orientation that the user may not have desired. Additionally, selecting points to place element 104 onto plane 102 may be hard because there is very little surface area on the ill-conditioned plane to place elements 102. For example, geometry is created in the system by the user positioning a cursor at the location on interface 100 where the geometry is desired and clicking a mouse. In the case of working on ill-conditioned planes, the location of the geometry is determined by projecting the location of the cursor in the direction of the view onto the plane, which may be far from what is intended.

### SUMMARY

In one embodiment, a method determines a first plane in a plurality of planes that is active for placing elements in a three dimensional (3D) space. A changing of a viewing direction of the first plane in the 3D space is detected. The method determines when a second plane in the plurality of planes should be activated for placing elements based on the changing of the viewing direction. The second plane is then activated for placing elements in the 3D space. The second plane is oriented at a different angle than the first plane with respect to the viewing direction.

In one embodiment, a non-transitory computer-readable storage medium is provided containing instructions for controlling a computer system to be operable to: determine a first plane in a plurality of planes that is active for placing elements in a three dimensional (3D) space; detect a changing of a viewing direction of the first plane in the 3D space; determine when a second plane in the plurality of planes should be activated for placing elements based on the changing of the viewing direction; and activate the second plane for placing elements in the 3D space, wherein the second plane is oriented at a different angle than the first plane with respect to the viewing direction.

In one embodiment, an apparatus includes: one or more computer processors and a computer-readable storage medium comprising instructions for controlling the one or more computer processors to be operable to: determine a first plane in a plurality of planes that is active for placing elements in a three dimensional (3D) space; detect a changing of a viewing direction of the first plane in the 3D space; determine when a second plane in the plurality of planes should be activated for placing elements based on the changing of the viewing direction; and activate the second plane for placing elements in the 3D space, wherein the second plane is oriented at a different angle than the first plane with respect to the viewing direction.

The following detailed description and accompanying drawings provide a more detailed understanding of the nature and advantages of the present invention.

### BRIEF DESCRIPTION OF THE DRAWINGS

FIG. 1 shows an example of a plane that has become ill-conditioned or edge-on.

FIG. 2 depicts a computing device for automatic grid alignment according to one embodiment.

FIG. 3 depicts a plane in an interface according to one embodiment.

FIG. 4 depicts an example of the interface when a viewing angle has been changed according to one embodiment.

FIG. 5 shows an example of placing a second element in the 3D space according to one embodiment.

FIG. 6 shows a different viewing direction of the 3D space according to one embodiment.

FIG. 7 depicts a simplified flowchart of a method for determining which plane to activate according to one embodiment.

FIG. 8 depicts a simplified flowchart of a method for a calculation for determining which plane to activate according to one embodiment.

### DETAILED DESCRIPTION

Described herein are techniques for a providing automatic plane alignment. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

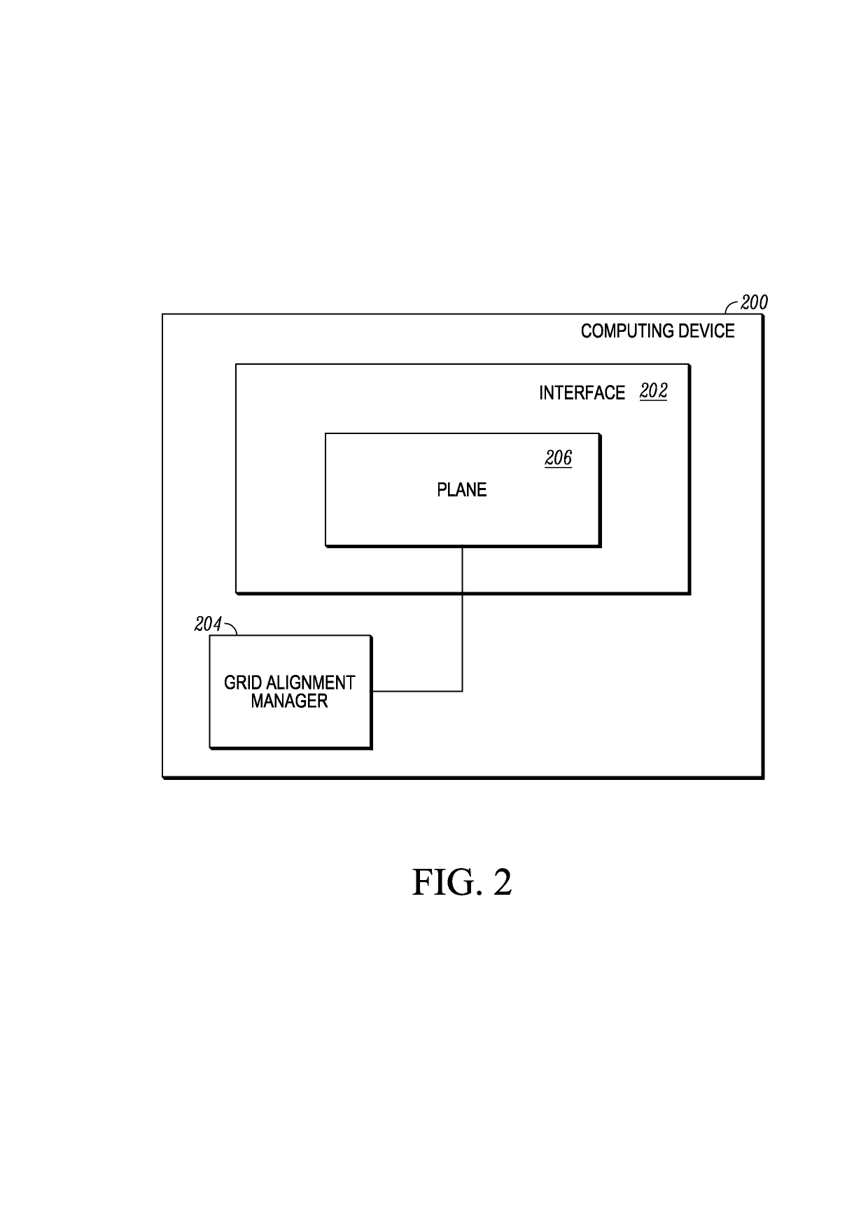

FIG. 2 depicts a computing device 200 for automatic grid alignment according to one embodiment. Computing device 200 includes an interface 202 that is used to place 3D elements into a 3D space. Interface 202 displays a plane 206 to a user. A user may then place 3D elements onto plane 206. At times, plane 206 may be rotated to view plane 206 from different viewing directions. For example, if plane 206 is an X-Y plane, then plane 206 may be initially viewed down a negative Z axis at one point. Then, for example, plane 206 may be rotated such that plane 206 is viewed substantially down the negative X axis (i.e., from a position to the right of the 3D elements on plane 206). The rotation will be described in further detail below.

Grid alignment manager 204 determines when plane 206 has become ill-conditioned or edge-on. For example, when plane 206 is rotated such that a viewing direction becomes substantially parallel to plane 206, a new plane 206 may be activated for placing 3D elements. New plane 206 may be at an orientation different from the prior plane 206. For example, new plane 206 may have a normal, which is a line perpendicular to the plane, that is more closely aligned to the viewing direction from a normal for the prior plane 206. This provides a user a new plane 206 that may be easier to place 3D elements on. Additionally, when a user places 3D elements on new plane 206, the elements may be placed in the 3D space in a position and orientation that may be more likely to be aligned with the user's intent.

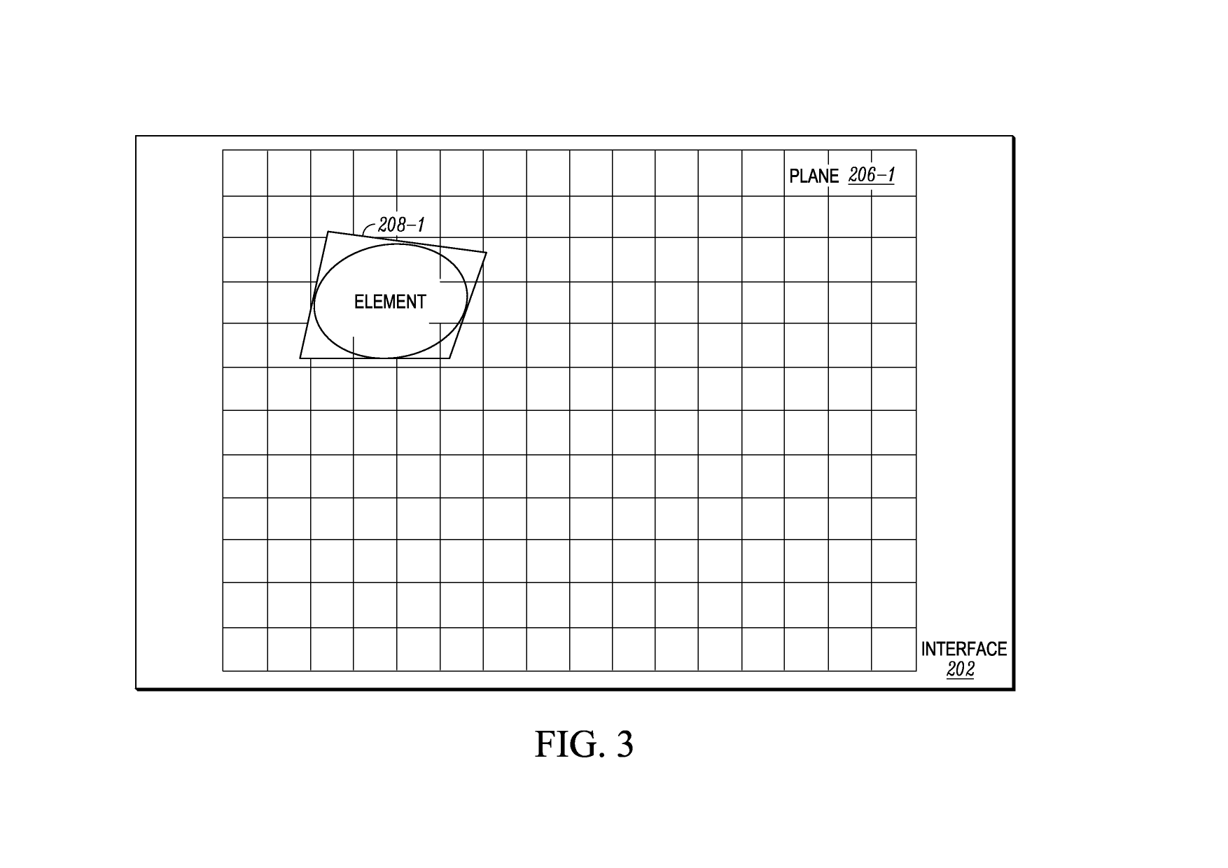

FIG. 3 depicts a plane 206-1 in interface 202 according to one embodiment. An element 208-1 has been placed in the 3D space on plane 206-1. Plane 206-1 is considered an active plane in which elements 208 are placed on plane 206-1. For example, when plane 206-1 is active, any elements 208 that are placed in a 3D space are placed on plane 206-1. Also, a grid is displayed on plane 206-1 to show it is activated. Element 208-1 has also been oriented at an angle to plane 206-1. For example, the user can orient element 208-1 in the 3D space with respect to plane 206-1. In one embodiment, element 208-1 may be transformed and projected with respect to plane 206-1. The transformation and projection applies depth and perception to element 208-1 with respect to plane 206-1. In one embodiment, the transformation and projection is performed in a browser-based environment. The browser-based environment treats individual elements 208 as being in a separate 3D space. Thus, each element 208 that is placed in the 3D space is transformed and projected with respect to the active plane 206-1 in which element 208 is placed.

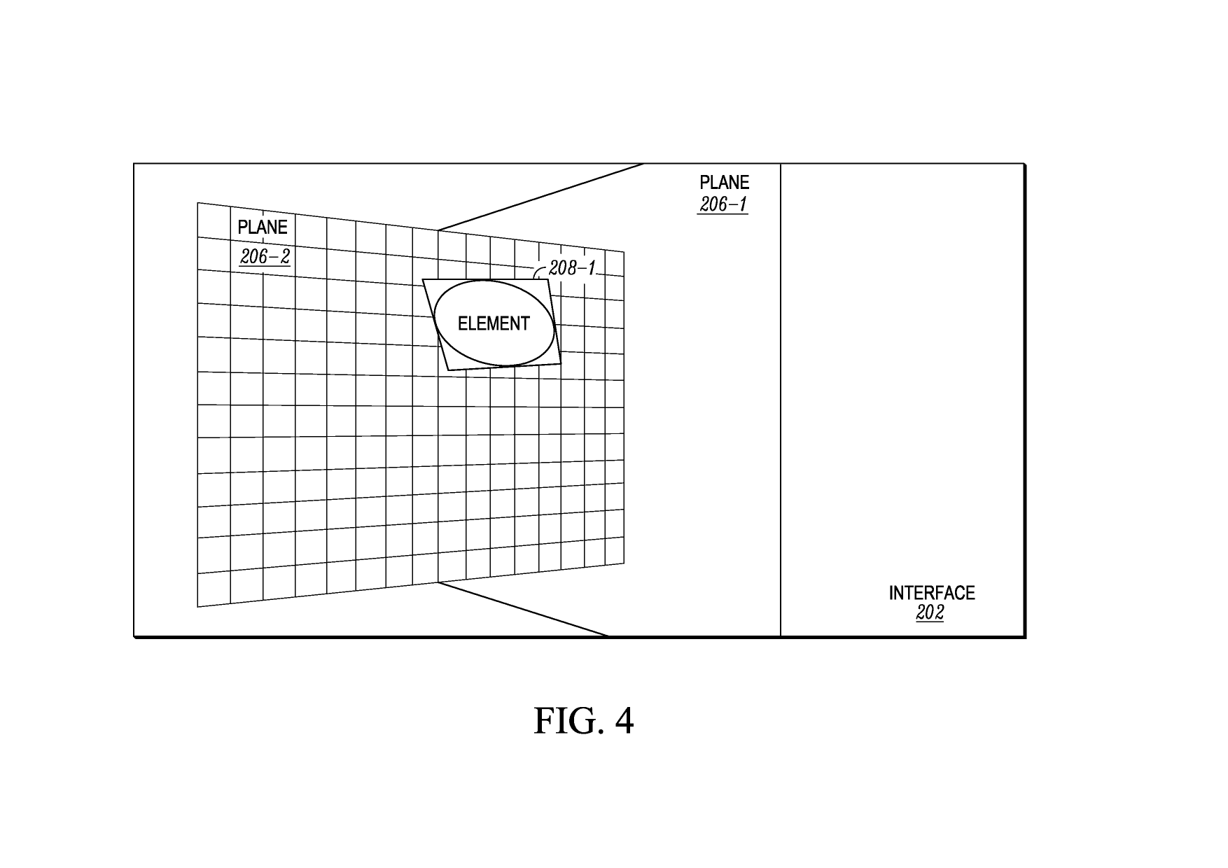

FIG. 4 depicts an example of interface 202 when a viewing direction has been changed according to one embodiment. Plane 206-1 has been oriented such that element 208-1 and plane 206-1 are being viewed from the right. That is, a viewing direction has been changed such that the observation point is off to the right of element 208-1 and plane 206-1 and the viewing direction is substantially towards the negative X direction. In this case, plane 206-1 may be considered ill-conditioned for placing elements 208 on. In response, grid alignment manager 204 dynamically determines a second plane 206-2 to activate. As shown, a grid on plane 206-2 indicates that this plane is active and when a user places an element 208 into the 3D space, that element 208 is placed on plane 206-2 instead of plane 206-1.

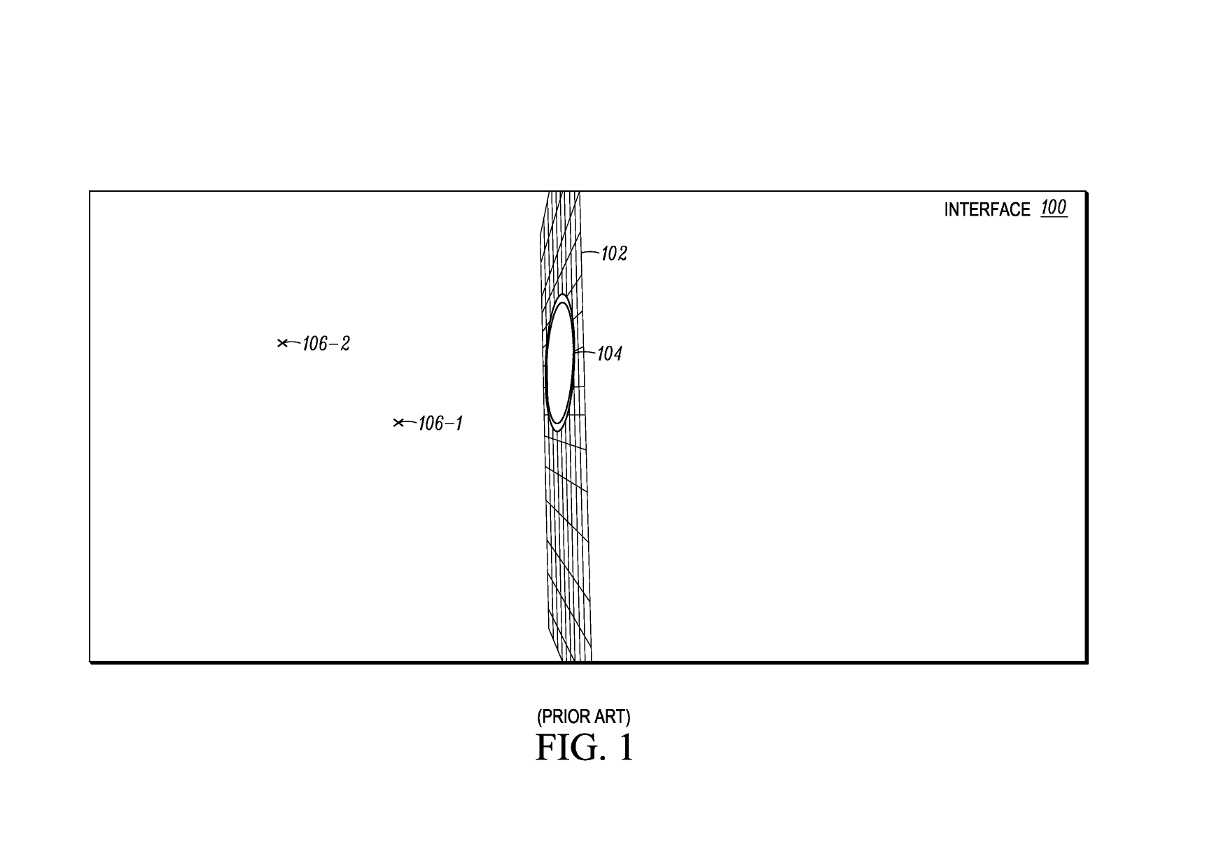

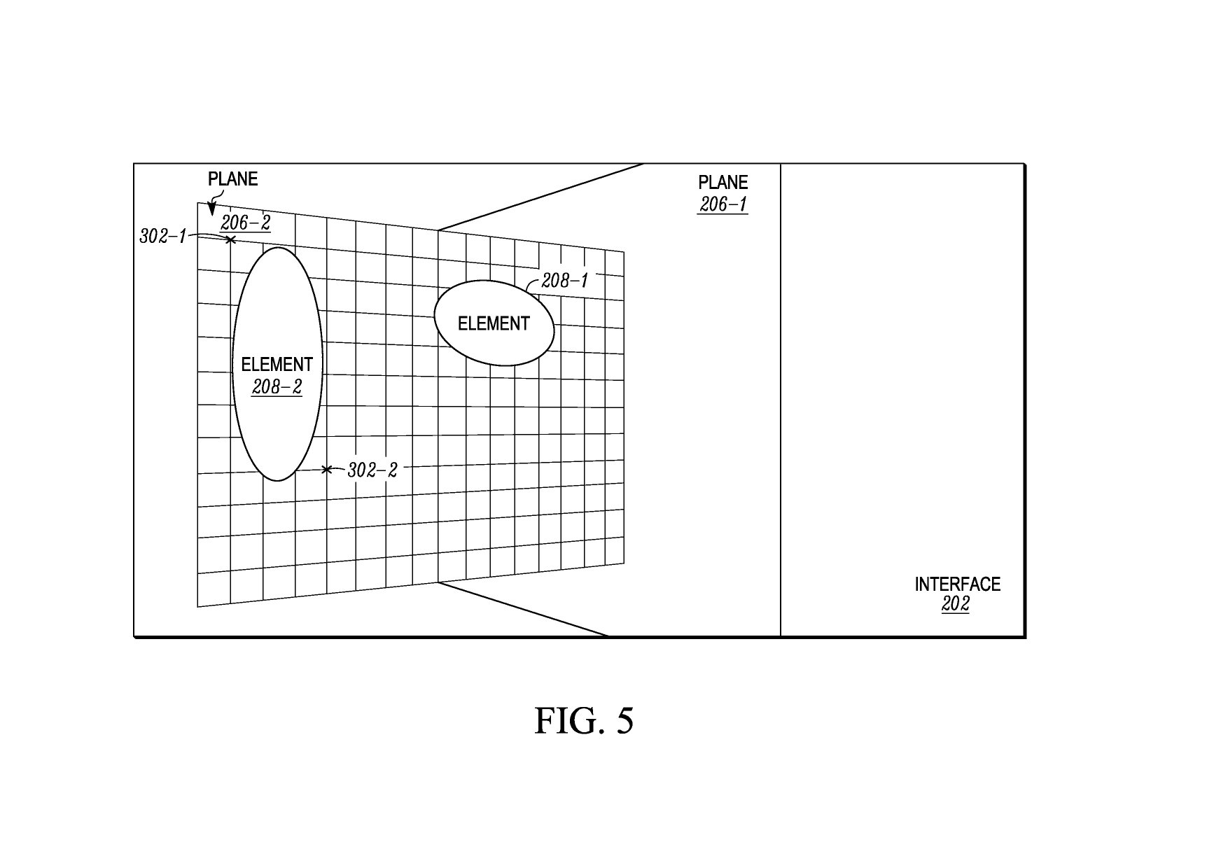

Plane 206-2 is activated for placing elements 208 because it may better represent where users want to place elements 208 in the 3D space and also provide more surface area to place elements 208. For example, FIG. 5 shows an example of placing a second element 208-2 in the 3D space according to one embodiment. As shown, element 208-2 has been placed into the 3D space on plane 206-2. To place element 208-2 into the 3D space, a user may select a first point 302-1 and a second point 302-2 on interface 202 using a cursor. In one embodiment, when a browser is being used, points 302-1 and 302-2 are used to transform and project element 208-2 with respect to plane 206-2. However, element 208-2 may be placed in the 3D space without any transform and projection. Geometry is created in the system using points 302-1 and 302-2. The location of the geometry is determined by projecting points 302-1 and 302-2 in the direction of the view onto second plane 206-2 instead of first plane 206-1. If points 302-1 and 302-2 were used to place element 208-2 onto plane 206-1, element 208-2 may not appear in the 3D space as the user intended. For example, element 208-2 may be placed onto plane 206-1 as shown in FIG. 1.

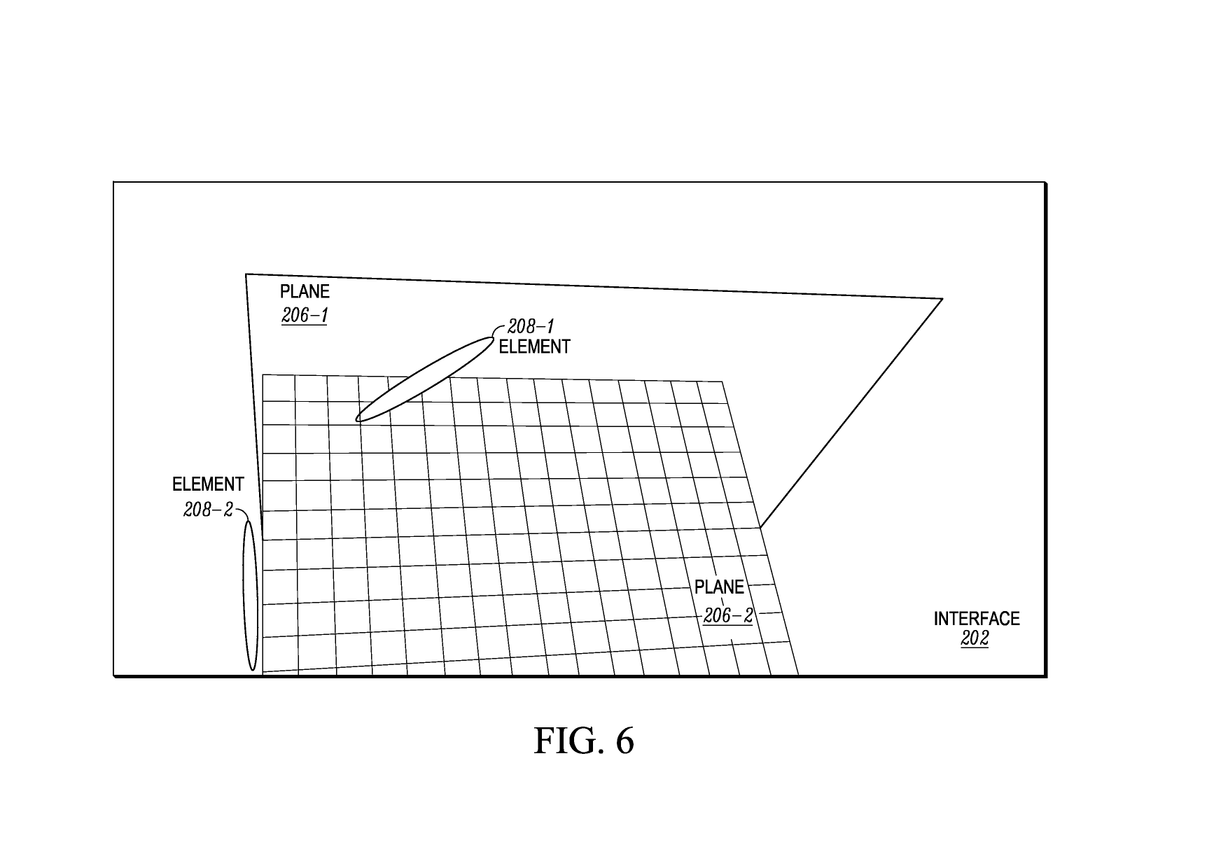

FIG. 6 shows a different viewing direction of the 3D space according to one embodiment. In this case, the viewing direction has been changed to be looking substantially down the negative Y direction. In this case, element 208-2 can be seen as being placed on the Y-Z plane. Additionally, element 208-1 is placed on the X-Y plane.

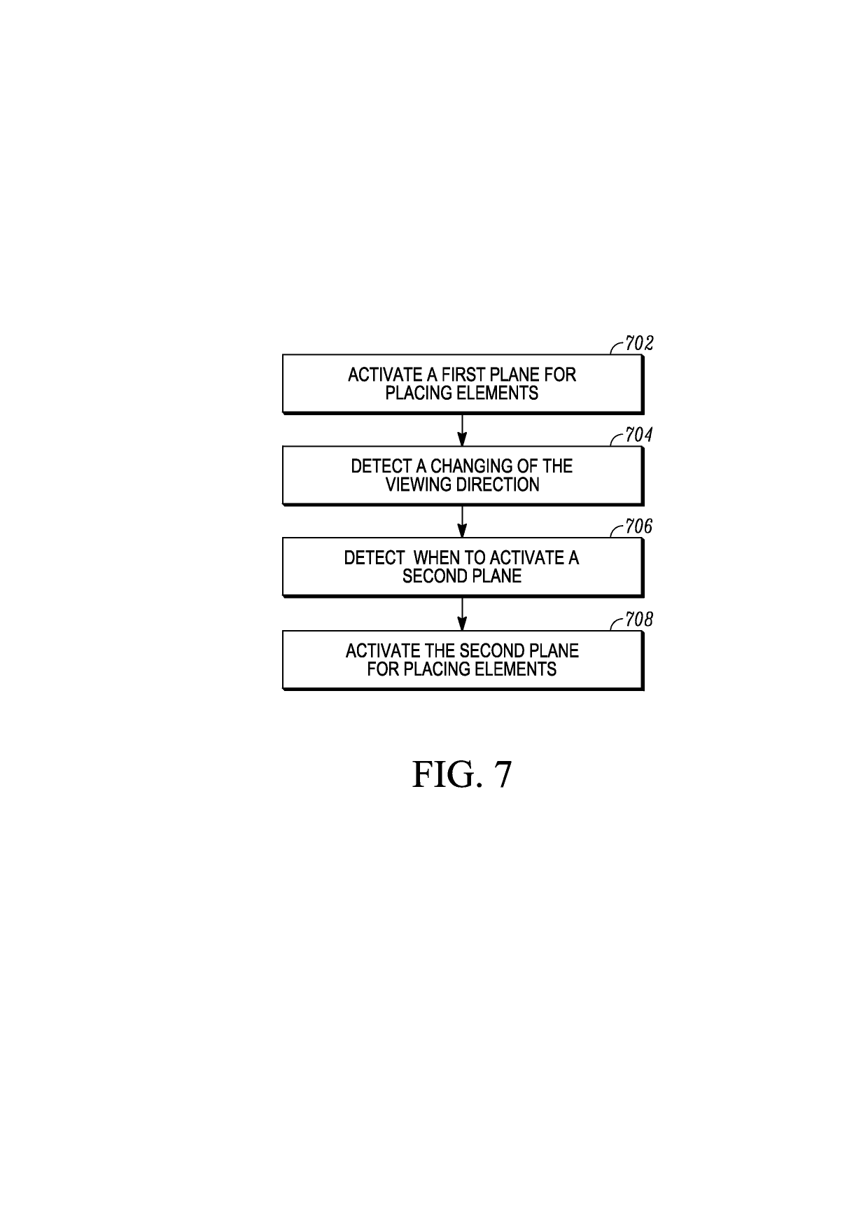

FIG. 7 depicts a simplified flowchart 700 of a method for determining which plane 206 to activate according to one embodiment. At 702, grid alignment manager 204 activates a first plane 206-1 for placing elements 208. If any elements 208 are placed in the 3D space while first plane 206-1 is activated, they are placed with respect to first plane 206-1.

At 704, grid alignment manager 204 detects a changing of the viewing direction. For example, a user may change the orientation of viewing the 3D space. For example, instead of viewing the 3D space down a negative Z direction, the user may rotate the 3D space to view it in a negative Y direction.

At 706, grid alignment manager 204 determines when to activate a second plane 206-2. For example, multiple pre-defined planes 206 may be provided that can be activated. In one embodiment, three planes 206 of an X-Y plane, a Y-Z plane, and an X-Z plane may be used. In other embodiments, additional planes 206 may be pre-defined or new planes are dynamically generated. Grid alignment manager 204 determines which one of these planes 206 should be activated based on a comparison of the orientation of the planes 206 to the viewing direction. One process of determining which plane 206 to activate will be described in more detail below.

At 708, grid alignment manager 204 activates second plane 206-2 for placing elements 208-2. For example, when grid alignment manager 204 determines second plane 206-2 would be better suited for placing elements 208 in the 3D space, second plane 206-2 is activated. This process may be continually performed as the viewing direction is changed.

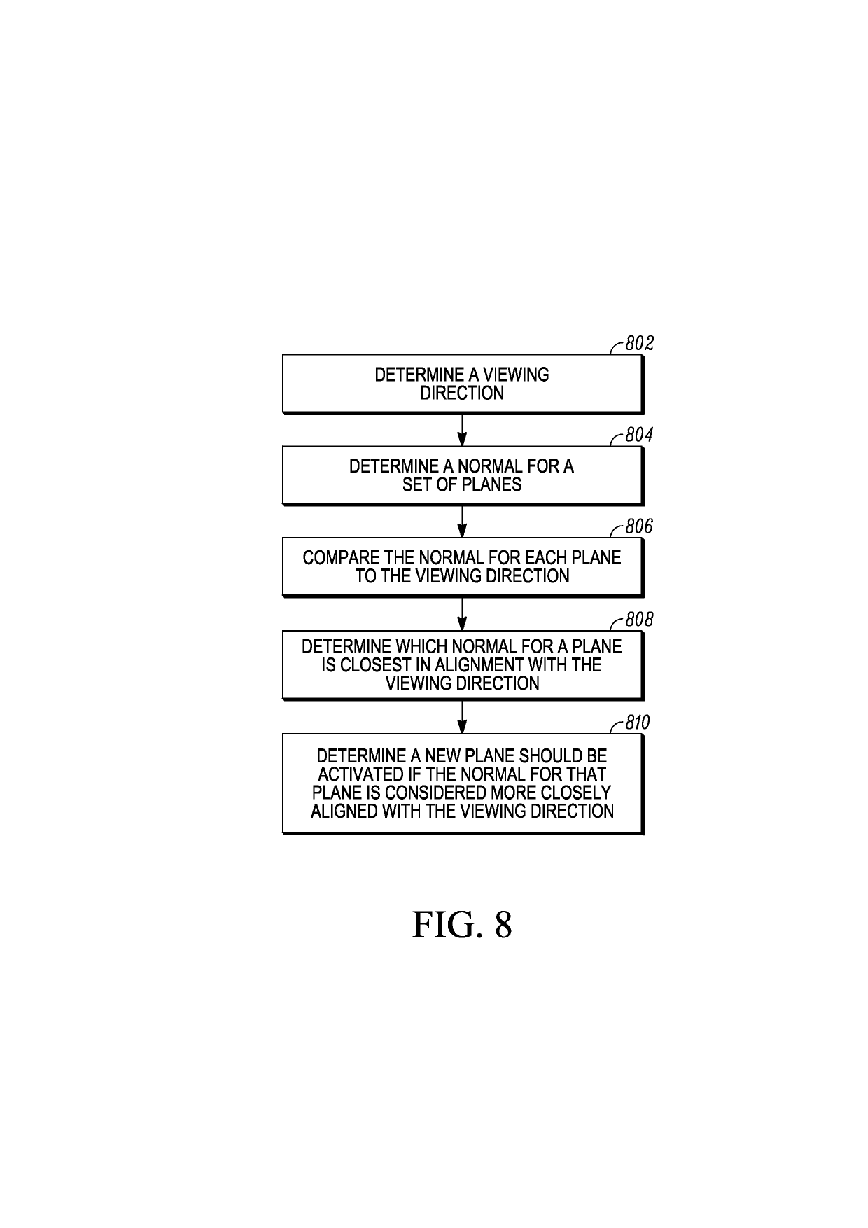

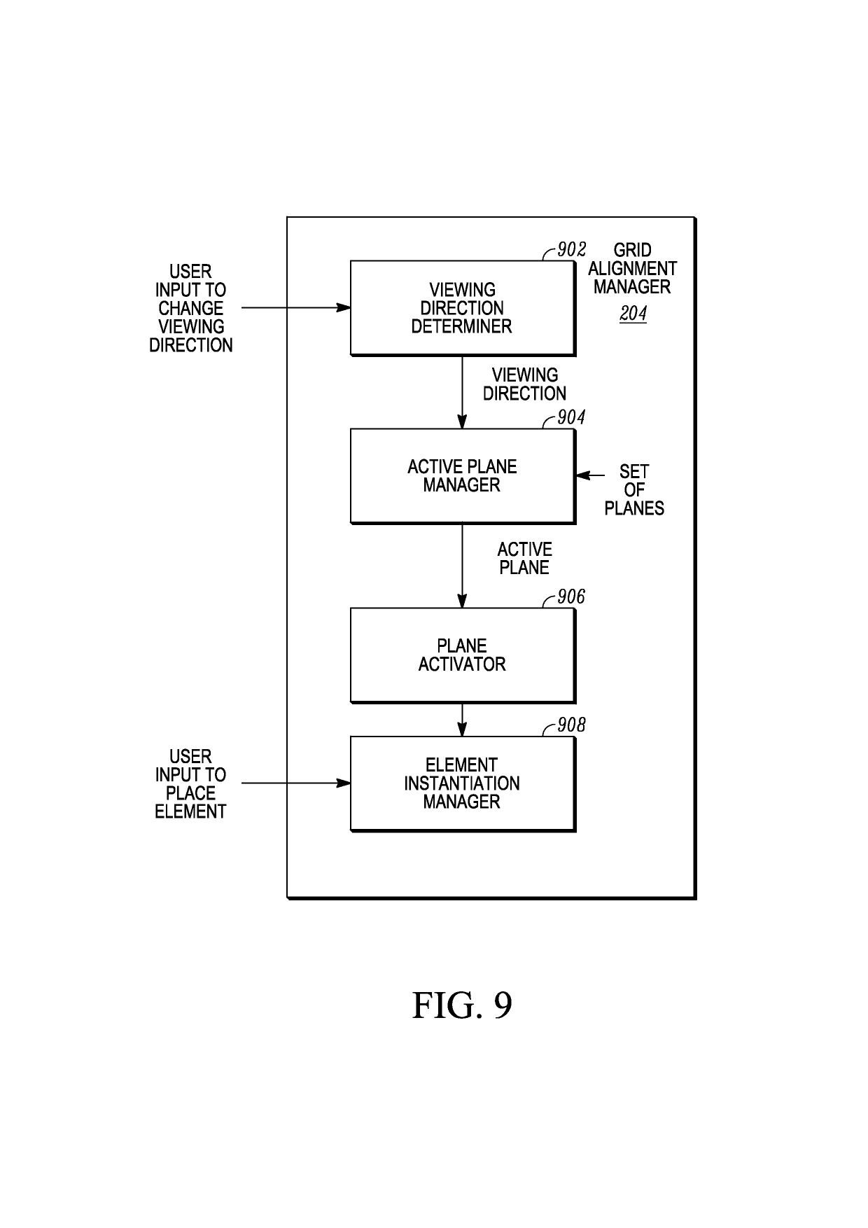

FIG. 8 depicts a simplified flowchart of a method for a calculation for determining which plane 206 to activate according to one embodiment. At 802, grid alignment manager 204 determines a viewing direction. For example, the current viewing direction is determined as it is being changed by a user. At 804, grid alignment manager 204 determines a normal for a set of planes. The normal for each plane may be a vector that is perpendicular to each plane. The set of planes 206 may be pre-defined or dynamically determined For example, grid alignment manager 204 may calculate an orientation to activate a new plane 206 dynamically.

At 806, grid alignment manager 204 compares normal for each plane 206 to the viewing direction. At 808, grid alignment manger 204 determines which normal for a plane 206 is closest in alignment with the viewing direction. For example, when a normal for a plane 206 that is not activated is more closely aligned with the viewing direction than an activated plane 206, then the plane 206 that is not activated may be a better candidate for placing elements 208. At 810, grid alignment manager 204 determines a new plane 206 should be activated if the normal for that plane is considered more closely aligned with the viewing direction. Other calculations may be used. For example, the normal does not need to be used to determine which plane to activate.

FIG. 9 depicts a more detailed example of grid alignment manager 204 according to one embodiment. A viewing direction determiner 902 determines a viewing direction based on input from a user changing the orientation of the 3D space. An active plane manager 904 receives the viewing direction and determines a set of planes 206 that are available to be activated. Active plane manager 904 then determines the normal for the set of planes 206 and determines if the normal for any plane 206 in the set of planes 206 is more closely aligned to the viewing direction than the normal for a current plane 206.

When active plane manager 904 determines a new plane 206 should be activated, a plane activator 906 activates the new plane 206 in interface 202. An element instantiation manager 908 receives input from a user to place elements 208 in the 3D space. Element instantiation manager 908 determines the active plane 206. Then, element instantiation manager 908 places element 208 on the active plane 206. In one embodiment, if a browser is being used, a transform and projection is performed to place element 208 in the 3D space on plane 206. Each individual element 208 that is placed in the 3D space is transformed and projected.

Accordingly, particular embodiments activate a plane 206 that has a normal considered to be more closely aligned with a viewing direction. This allows the user to place elements 208 in a position and orientation in the 3D space on an activated plane 206 that is more likely to be closer to the user's intent. Also, this gives a user a clear, unambiguous plane 206 to place elements 208 on and an activated plane 206 does not become ill-conditioned by looking at plane 206 from a viewing direction that is parallel or substantially parallel to the viewing direction.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents may be employed without departing from the scope of the invention as defined by the claims.

What is claimed is:

1. A method comprising:
determining a first plane in a plurality of planes that is active for placing elements in a three dimensional (3D) space;
detecting a changing of a viewing direction of the first plane in the 3D space;
determining when a second plane in the plurality of planes should be activated for placing elements based on the changing of the viewing direction; and
activating, by a computing device, the second plane for placing elements in the 3D space, wherein the second plane is oriented at a different angle than the first plane with respect to the viewing direction.

2. The method of claim 1, further comprising:
receiving a placement of a first element in the 3D space while the first plane is activated; and
placing the first element on the first plane.

3. The method of claim 2, further comprising:
after placing the first element on the first plane, receiving a placement of a second element in the 3D space while the second plane is activated; and
placing the second element on the second plane.

4. The method of claim 1, further comprising:
receiving coordinates for placing an element in the 3D space; and
using the coordinates to place the element in a position and orientation onto either of the first plane or the second plane based on which of the first plane and the second plane is activated.

5. The method of claim 1, wherein determining when the second plane for placing elements should be activated comprises:
comparing orientations of the plurality of planes to the viewing direction; and
determining a plane to activate based on the comparison.

6. The method of claim 5, wherein:
comparing orientations comprises comparing a normal of each of the plurality of planes to the viewing direction, and
activating comprises activating a plane that has a normal most closely aligned to the viewing direction.

7. The method of claim 1, wherein:
three or more planes are predefined in the plurality of planes, the three or more planes including the first plane, the second plane, and a third plane, and
one of the three or more planes is activated based on a comparison of an orientation of the three of more planes to the viewing direction.

8. The method of claim 1, wherein the 3D space is displayed in a browser, wherein each element that is placed in the 3D space is transformed and projected with respect either of the first plane or the second plane based on which of the first plane and the second plane is activated.

9. A non-transitory computer-readable storage medium containing instructions for controlling a computer system to be operable to:
determine a first plane in a plurality of planes that is active for placing elements in a three dimensional (3D) space;
detect a changing of a viewing direction of the first plane in the 3D space;
determine when a second plane in the plurality of planes should be activated for placing elements based on the changing of the viewing direction; and
activate the second plane for placing elements in the 3D space, wherein the second plane is oriented at a different angle than the first plane with respect to the viewing direction.

10. The non-transitory computer-readable storage medium of claim 9, further operable to:
receive a placement of a first element in the 3D space while the first plane is activated; and
place the first element on the first plane.

11. The non-transitory computer-readable storage medium of claim 10, further operable to:
after placing the first element on the first plane, receive a placement of a second element in the 3D space while the second plane is activated; and
place the second element on the second plane.

12. The non-transitory computer-readable storage medium of claim 9, further operable to:
receive coordinates for placing an element in the 3D space; and
use the coordinates to place the element in a position and orientation onto either of the first plane or the second plane based on which of the first plane and the second plane is activated.

13. The non-transitory computer-readable storage medium of claim 9, wherein determine when the second plane for placing elements should be activated comprises:
compare orientations of the plurality of planes to the viewing direction; and
determine a plane to activate based on the comparison.

14. The non-transitory computer-readable storage medium of claim 13, wherein:
compare orientations comprises compare a normal of each of the plurality of planes to the viewing direction, and
activate comprises activate a plane that has a normal most closely aligned to the viewing direction.

15. The non-transitory computer-readable storage medium of claim 9, wherein:
three or more planes are predefined in the plurality of planes, the three or more planes including the first plane, the second plane, and a third plane, and
one of the three or more planes is activated based on a comparison of an orientation of the three of more planes to the viewing direction.

16. The non-transitory computer-readable storage medium of claim 9, wherein the 3D space is displayed in a browser, wherein each element that is placed in the 3D space is transformed and projected with respect either of the first plane or the second plane based on which of the first plane and the second plane is activated.

17. An apparatus comprising:
one or more computer processors; and
a computer-readable storage medium comprising instructions for controlling the one or more computer processors to be operable to:
determine a first plane in a plurality of planes that is active for placing elements in a three dimensional (3D) space;
detect a changing of a viewing direction of the first plane in the 3D space;
determine when a second plane in the plurality of planes should be activated for placing elements based on the changing of the viewing direction; and
activate the second plane for placing elements in the 3D space, wherein the second plane is oriented at a different angle than the first plane with respect to the viewing direction.

18. The apparatus of claim 17, further operable to:
receive a placement of a first element in the 3D space while the first plane is activated; and
place the first element on the first plane.

19. The apparatus of claim 17, further operable to:
after placing the first element on the first plane, receive a placement of a second element in the 3D space while the second plane is activated; and
place the second element on the second plane.

20. The apparatus of claim 17, further operable to:
receive coordinates for placing an element in the 3D space; and
use the coordinates to place the element in a position and orientation onto either of the first plane or the second plane based on which of the first plane and the second plane is activated.
